(19) United States
(12) Patent Application Publication
(10) Pub. No.: US 2025/0187938 A1
(43) Pub. Date: Jun. 12, 2025

(54) Aluminum Chloride Derivatives Produced in a Multi-Zone Oven

(71) Applicant: USALCO, LLC, Baltimore, MD (US)

(72) Inventors: Anton Treuting, Cuddebackville, NY (US); John Matthew Bowlsbey, Churchville, MD (US); James M. Dulko, Annapolis, MD (US); Michael J. Gentile, Wilmington, DE (US); Paul Haugen Loberg, Silver Spring, MD (US)

(21) Appl. No.: 18/977,488

(22) Filed: Dec. 11, 2024

Related U.S. Application Data
(60) Provisional application No. 63/608,777, filed on Dec. 11, 2023.

(51) Int. Cl. C01F 7/57; H05B 3/00

(52) U.S. Cl. CPC C01F 7/57; H05B 3/0038

(57) ABSTRACT

A system for producing particles of basic aluminum chloride includes a liquid feed system configured to have a liquid solution of aluminum chloride and configured to dispense droplets of the liquid solution, the droplets having an average size of about 0.5 mm to about 15 mm in diameter and spaced apart from one another, at least one conveyor belt having a surface configured to hold the droplets, a first heating zone having at least one radiant heat source configured to heat the liquid solution on the surface to concentrate the aluminum chloride, and a second heating zone having at least one radiant heat source configured to heat the concentrated aluminum chloride to decompose the aluminum chloride and produce the particles of basic aluminum chloride. The method includes dispensing and heating the droplets in a particular way to produce the particles of the basic aluminum chloride.

### CROSS-REFERENCE TO RELATED APPLICATIONS

This application claims the benefit of U.S. Provisional Patent Application No. 63/608,777, filed Dec. 11, 2023, the disclosure of which is incorporated herein by reference in its entirety.

### TECHNICAL FIELD

The present invention relates to the production of aluminum chloride derivatives, and more particularly to the production of basic aluminum chloride dry product from aluminum chloride solutions.

### BACKGROUND ART

There are several processes to make various basicity basic aluminum chloride (BAC) from aluminum chloride solutions (ACS). Typical processes include digesting aluminum metal in aluminum chloride solutions, digesting aluminum oxide trihydrate in aluminum chloride solutions in atmospheric and pressure reactors and crystalizing aluminum chloride hexahydrate from aluminum chloride solutions and decomposing the crystals by heating and increasing the basicity. Each of these processes have a drawback such as expensive raw materials, energy inefficient, high capital costs, limited basicity ranges, difficult material handling and generation of weak hydrochloric acid solutions.

### SUMMARY OF THE EMBODIMENTS

In accordance with one embodiment of the invention, a method for producing particles of basic aluminum chloride includes dispensing droplets of a first liquid solution of aluminum chloride onto a surface and heating the droplets of the first liquid solution with a first radiant heat source to concentrate the aluminum chloride to form at least partially dried particles of aluminum chloride. The method further includes dispensing droplets of a second liquid solution of aluminum chloride onto the surface between the at least partially dried particles of aluminum chloride from the first liquid solution and heating the droplets of the second liquid solution with a second radiant heat source to concentrate the aluminum chloride to form at least partially dried particles of aluminum chloride. The method further includes heating the at least partially dried particles of aluminum chloride from the first liquid solution and from the second liquid solution with a third radiate heat source to decompose the at least partially dried particles of aluminum chloride to produce the particles of the basic aluminum chloride.

In accordance with another embodiment of the invention, a system for producing particles of basic aluminum chloride includes a liquid feed system configured to have a liquid solution of aluminum chloride and configured to dispense droplets of the liquid solution, the droplets having an average size of about 0.5 mm to about 15 mm in diameter and spaced apart from one another. The system further includes at least one conveyor belt having a surface configured to hold the droplets, a first heating zone having at least one radiant heat source configured to heat the liquid solution on the surface to concentrate the aluminum chloride, and a second heating zone having at least one radiant heat source configured to heat the concentrated aluminum chloride to decompose the aluminum chloride and produce the particles of basic aluminum chloride.

In related embodiments, the surface may be at least one conveyor belt configured to hold the droplets. The conveyor belt may be made of fiberglass coated with polytetrafluoroethylene (PTFE). The surface may be textured to hold the droplets. The first radiant heat source and/or the second radiant heat source may include at least one electric powered heating element provided above and/or laterally adjacent to the surface. The first radiant heat source and/or the second radiant heat source may be provided perpendicular and/or parallel to a motion of the surface. If the first radiant heat source and/or the second radiant heat source is provided parallel to the motion of the surface, then the first radiant heat source and/or the second radiant heat source may be inclined relative to the surface so that one end is further away from the surface than another end causing a radiant differential heating of the droplets. The first radiant heat source and/or the second radiant heat source may be provided about 6 inches from the surface. The first radiant heat source and the second radiant heat source may be the same heat source. The first liquid solution and the second liquid solution may be from one liquid source with the same concentration. The first liquid solution may have a different concentration than the second liquid solution. The droplets may have an average size of about 0.5 mm to about 15 mm in diameter and be spaced apart from one another. The method may further include adding water to the at least partially dried particles of aluminum chloride from the first liquid solution and/or from the second liquid solution to protect the at least partially dried particles from oxidation when decomposing to produce the particles of the basic aluminum chloride. The method may further include adding water to the particles of the basic aluminum chloride to change waters of hydration of the basic aluminum chloride and bulk density and solubility of the basic aluminum chloride. The method may further include collecting gas emitted from the heated first liquid solution, the heated second liquid solution, and/or the heated at least partially dried particles of aluminum chloride. The gas may include steam and/or hydrochloric acid released from the heated first liquid solution, the heated second liquid solution, and/or the heated at least partially dried particles of aluminum chloride. The method may further include collecting heat emitted from the heated first liquid solution, the heated second liquid solution, and/or the heated at least partially dried particles of aluminum chloride. The liquid feed system may include a manifold with spaced apart apertures configured to dispense the droplets. The system may be configured to control a size and density of the droplets by flowrate or pulse rate control. The system may further include one or more gas collectors configured to collect gas emitted from the first heating zone and/or the second heating zone. The system may further include one or more heat recouperators configured to collect heat emitted from the first heating zone and/or the second heating zone. The system may further include one or more reflectors configured to return radiant energy to the surface reflected from the at least one radiant heat source in the first heating zone and/or from the at least one radiant heat source in the second heating zone. The first heating zone may have a temperature ranging from about 235 deg F. to about 400 deg F., preferably ranging from about 245 deg F. to about 300 deg F. The second heating zone may have a temperature ranging from about 250 deg F. to about 450 deg F., preferably ranging from about 315 deg F. to about 390 deg F.

In accordance with another embodiment of the invention, a basic aluminum chloride dry product is produced according to any of the methods mentioned above.

### BRIEF DESCRIPTION OF THE DRAWINGS

The foregoing features of embodiments will be more readily understood by reference to the following detailed description, taken with reference to the accompanying drawings, in which:

FIG. 1 shows a conveyor belt system used to manufacture basic aluminum chloride (BAC) or basic aluminum chlorosulfate (BACS) dry products from aluminum chloride solutions according to embodiments of the present invention;

FIG. 2 is a photograph of a furnace box prototype used to manufacture basic aluminum chloride (BAC) dry products from aluminum chloride solutions according to embodiments of the present invention;

FIG. 3 is a schematic drawing of an exemplary electric quartz heater used in the furnace box prototype of FIG. 2 according to embodiments of the present invention;

FIGS. 4A-4C are schematic drawings showing a top view, a front view and a side view, respectively, of an oven used in the furnace box prototype of FIG. 2 according to embodiments of the present invention; and

FIG. 5 is a schematic drawing of an exemplary continuous belt process oven according to embodiments of the present invention.

### DETAILED DESCRIPTION OF SPECIFIC EMBODIMENTS

Embodiments of the present invention provide a system and method to produce basic aluminum chloride (BAC) from aluminum chloride solutions. A solution of aluminum chloride may be a solution of Basic Aluminum Chloride (BAC) consisting of about 10% to 18% aluminum oxide solution with about 1% free hydrochloric acid to about 9% OH, and about 18% to 25% chloride. The system and method concentrate and decompose aluminum chloride in a multi-zone drying process that produces a variety of basic aluminum chloride products. The final BAC product basicity may be varied by adjusting various parameters of the system, e.g., the initial basicity of the liquid feed stock, the feed rate of liquid onto the surface, the number of locations the liquid is fed onto the surface, the speed of the surface, and number of sequential discrete heating zones, the temperatures created by the radiant infra-red heating, e.g., using electric heating elements or other kinds of heating elements, in each discrete heating zone, and/or gas extraction flow rates from each heating zone. The system and process minimize the production of hard to dissolve species and produce a wide range of basicites from low basicity to high basicity that can be used for different applications in a highly energy efficient manner. Specifically, the system and method may produce basic aluminum chlorides ranging from about 23 to about 83 percent basicity using a multi-zone controlled oven process. The system and process are tailored to avoid producing aluminum chloride hexahydrate.

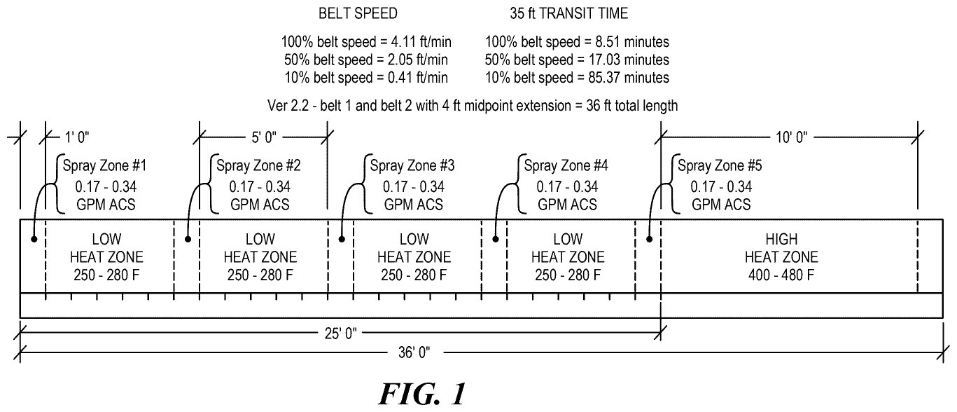

A system for producing particles of basic aluminum chloride according to embodiments of the present invention includes a liquid feed system configured to dispense droplets of a liquid solution of aluminum chloride. The droplets have an average size ranging from about 0.5 mm to about 15 mm in diameter and are spaced apart from one another. The system further includes at least one conveyor belt having a surface configured to hold the droplets, such as shown in FIG. 1. The system with its multi-zone oven has the capability of varying the number of heating zones depending on the basicity of the desired end product with lower basicity product typically requiring less heating zones and higher basicity product typically requiring more heating zones. The heating of these zones can be provided by one or more radiant heat sources, such as quartz heating elements. The first heating zone(s) are an evaporation zone where the aluminum chloride solution is concentrated. The temperature for the first heating zone(s) for dewatering the aluminum chloride solution ranges from about 235° F. to about 400° F., preferably about 245° F. to about 300° F. The aluminum chloride solution is not concentrated above its saturation point in order to avoid the production of hexahydrate crystals. It has been discovered that more energy is required to decompose the hexahydrate crystal than a concentrated solution of aluminum chloride. In the concentration heating zone(s), water is released from the aluminum chloride solution with some free hydrochloric acid (HCl). This very dilute hydrochloric acid solution can be used in the production of aluminum chloride or used as dilution water to put the dry BACs in solution. The condensate from the earlier zones may be kept separate from the condensates of the other zones so that the concentrated HCl generated from the other zones is not diluted. This recovered HCl can be recycled and used to make aluminum chloride solutions.

A process of producing a basic aluminum chloride dry product according to embodiments of the present invention begins with dispensing droplets of an aluminum chloride solution onto a surface, such as a conveyor belt, in such a way that droplets of the solution form on the surface. The controlled dispensing of the droplets is beneficial over spraying, which produces corrosive mists and results in loss of product. In addition, the movement of air from spraying may force the droplets together and cause pooling of the solution, resulting in the subsequent uneven heating of the solution. The surface moves the droplets into an oven where a series of one or more radiant heating sources, such as quartz heating tubes, heat the droplets to evaporate and concentrate the aluminum chloride solution. The vapor from this evaporation process includes steam with a trace amount of HCl. The temperature of the surface and rate of evaporation are controlled to maximize water evaporation and minimize HCl evolution. The droplets continue into a second area where the at least partially dried particles of aluminum chloride continue to be heated by one or more radiant heat sources.

The system and method dispense another round of droplets in the voids between the droplets already on the surface, allowing more loading on the surface and increasing dryer efficiency. This process may be repeated multiple times to continue dispensing droplets onto the surface and filling the voids along with the subsequent heating to concentrate the droplets of aluminum chloride and evaporate the water to form at least partially dried particles of aluminum chloride. The droplets may also be dispensed onto the concentrated and at least partially evaporated, dried material already on the surface, preventing the formation of insoluble species. This allows the material on the surface to have even more time for drying as the dispensed droplets increase the heat conductivity on the surface while the interior of the material on the surface continues to dry and, if the temperature is high enough in the heating zone, decompose. This process can be repeated in subsequent zones in the oven. When the desired amount of droplets have been dispensed, preferably an amount sufficient to fill in all or substantially all voids on the surface, then the at least partially dried particles of the aluminum chloride are further heated in a second decomposition heating zone in order to decompose the particles to produce the particles of the basic aluminum chloride.

The evaporate from the second heating zone may be kept separate from the evaporate from the first heating zone(s) since the evaporate from the second heating zone may contain predominantly HCl with steam. Depending on the ratio of steam to HCl, the evaporate can be directed where it makes the most concentrated acid and the lowest concentration of HCl in water. The concentration of HCl can be higher than 30% concentration. The speed of the conveyor belt surface and the temperatures of the various zones can be optimized to produce BAC particles that have high solubility and a desired basicity. The temperature ranges for the decomposition heating zone, which releases HCl vapor, is about 250° F. to about 450° F. and preferably about 315° F. to about 390° F. If the particles on the surface are heated too fast, the surface of the particles create a high basicity insoluble surface. This insoluble surface acts like an insulator and causes overheating of the surface and under heating of the interior area of the particle. This produces products of mixed basicites that can cause problems like increased hygroscopicity on some material and ineffective, cloudy material on others. Heating can be paused or lowered to give time for heat to dissipate through the particle and give time for HCl and steam to leave the particle in an additional heating zone. Heat can be returned in another subsequent heating zone. The residual moisture of the dry BAC or BACS may be controlled by introducing water, e.g., a mist or steam, on the particles. This decreases the amount of insoluble product and increases the solubility and density of the end product. This is especially important when the desired product is high basicity, for example 70% basicity or higher. The water may be dispensed as droplets at one or more locations along the conveyor system for the purpose of protecting the dry particle products from oxidation during decomposition removal of HCl, and for tailoring the final product associated waters of hydration and tailoring the product powder/granular bulk density and solubility.

Embodiments of the present invention are able to produce products as described with the below chemical formulas:

TABLE 1
Basic Aluminum Chloride Dry Product Formula Range

| | Al/Cl | Al/OH | Basicity | |
|---|---|---|---|---|
| Formula | atomic ratio | atomic ratio | Comments | |
| Al Cl₃ 6H₂0 | 0.3333 | n/a | 0.0% | |
| Al₂ (OH)1.5 Cl 4.5 * (n)H₂0 | 0.4444 | 1.3333 | 25.0% | “drying” range (20-24% basic) |
| Al₂ (OH)2.0 C1 4.0 * (n)H₂0 | 0.5000 | 1.0000 | 33.3% | |
| Al₂ (OH)2.5 Cl 3.5 * (n)H₂0 | 0.5714 | 0.8000 | 41.7% | |
| Al₂ (OH)3.0 Cl 3.0 * (n)H₂0 | 0.6667 | 0.6667 | 50.0% | |
| Al₂ (OH)3.5 Cl 2.5 * (n)H₂0 | 0.8000 | 0.5714 | 58.3% | |
| Al₂ (OH)3.75 Cl 2.25 * (n)H₂0 | 0.8889 | 0.5333 | 62.5% | |
| Al₂ (OH)4.0 C1 2.0 * (n)H₂0 | 1.0000 | 0.5000 | 66.7% | |
| Al₂ (OH)4.25 Cl 1.75 * (n)H₂0 | 1.1429 | 0.4706 | 70.8% | |
| Al₂ (OH)4.5 Cl 1.5 * (n)H₂0 | 1.3333 | 0.4444 | 75.0% | sesquichlorohydrate |
| Al₂ (OH)4.75 Cl 1.25 * (n)H₂0 | 1.6000 | 0.4211 | 79.2% | sesquichlorohydrate |
| Al² (OH)5.0 Cl * (n)H₂0 | 2.0000 | 0.4000 | 83.3% | ACH |

The system according to embodiments of the present invention includes an oven that can be built of suitable materials to prevent corrosion of parts. Suitable metals can be coated with corrosive resistant coatings, e.g., such as enamels. For example, the oven materials may be coated with one or more coatings that are able to tolerate the heat, infrared radiation, and hydrochloric acid and steam mixture, e.g., porcelain enameled steel, Metco 136F chromium oxide-silica composite powder, spray coating of PPG HI-TEMP 1000, Belzona 1593, and similar coatings as known by one skilled in the art. The one or more conveyor belts can be one long continuous belt or a series of belts. The belts can be stacked to minimize space. Suitable material for the belt is fiberglass coated with PTFE or other materials that tolerate the heat or corrosive environment. The oven should contain a gas collection system capable of separating the gas generated in the earlier evaporation zones from the gas, such as the higher HCl concentration vapors, generated from the later heating zones. Areas of the oven may include separations with adjustable dampers and manometers for controlling the air pressure or vacuum. The gases may be collected with a vapor collection system. This system may be under a few inches of water of vacuum.

The one or more radiant heat sources for the oven may be electric powered quartz tubes, e.g., tubes composed of either clear quartz, or “satin” fogged finished, to modify the infra-red radiation frequencies. These quartz tubes can contain a partial internal or a partial or complete exterior reflector that directs the thermal energy toward the sample product to be dried and converted. To optimize even heating, electrical heating elements may be horizontally or vertically aligned relative to the motion of the material on the conveyor belt surface, above and/or laterally adjacent to the surface. The one or more radiant heating sources may be parallel or perpendicular, or both parallel and perpendicular, to the direction of travel of the material on a conveyor belt surface. If aligned parallel to the motion of the material on the conveyor belt surface, the infrared heating elements may be inclined or tilted such that one end of the radiant heating source is higher or further away from the heated surface than the other end, causing a radiant differential heating exposure of the material from one end of the length or the heating element to the other end.

The oven is equipped with one or more manifold systems for dispensing liquids on to the conveyor belt surface. The manifold(s) may include spaced apart apertures which create and deposit distinct individual droplets of liquid favorable for drying and decomposing into higher basicities. The droplets from the manifold may range from about 0.5 mm to 15 mm in diameter, and preferably are uniformly separated from each other for optimum thermal drying and decomposition. The droplets may be controlled by flowrate and/or pulse rate control methods.

Embodiments of the present invention provide a process to create a complete range of basicities of final dry product ranging from a low basicity of around 24% basic to a high basicity range of about 83% basic. The ability to control the final product basicity is a function of the various parameters of the system, e.g., liquid ACS droplet size, and distribution, time at single temperature and/or time at sequential temperatures. For example, embodiments of the present invention may make an approximately 40% basic powder through one pass of the oven. The powder may then either be refed into the oven or a similar oven to make even higher basic material. This process also allows a more concentrated hydrochloric acid to be formed while making the high basic products and a more dilute HCl solution to be formed while making the 40% basic products.

### EXAMPLES

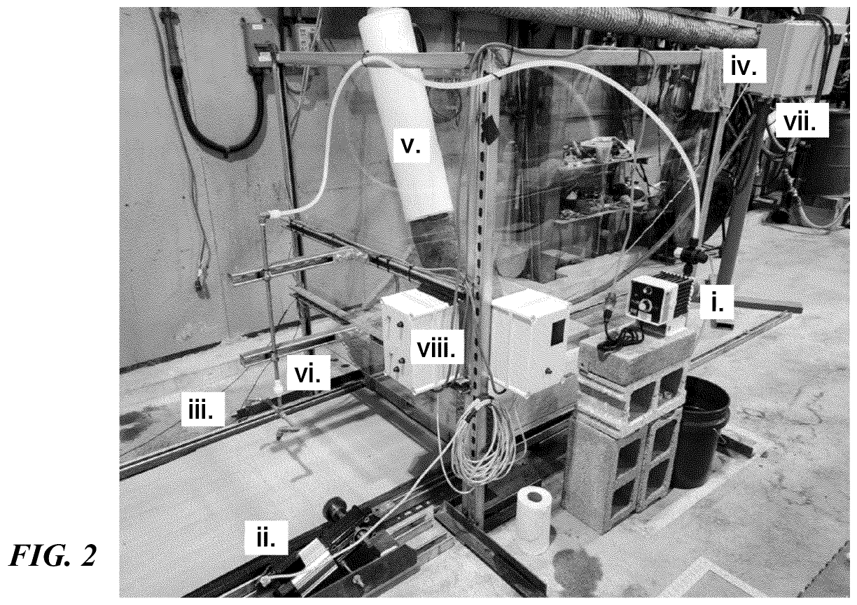

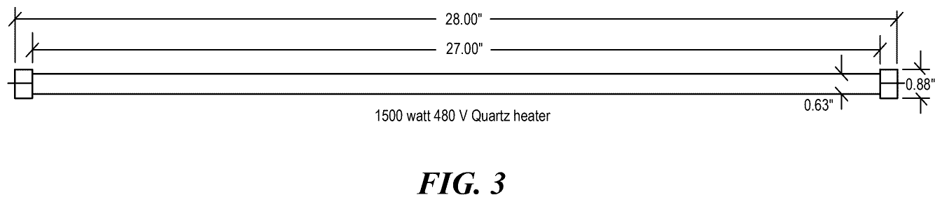

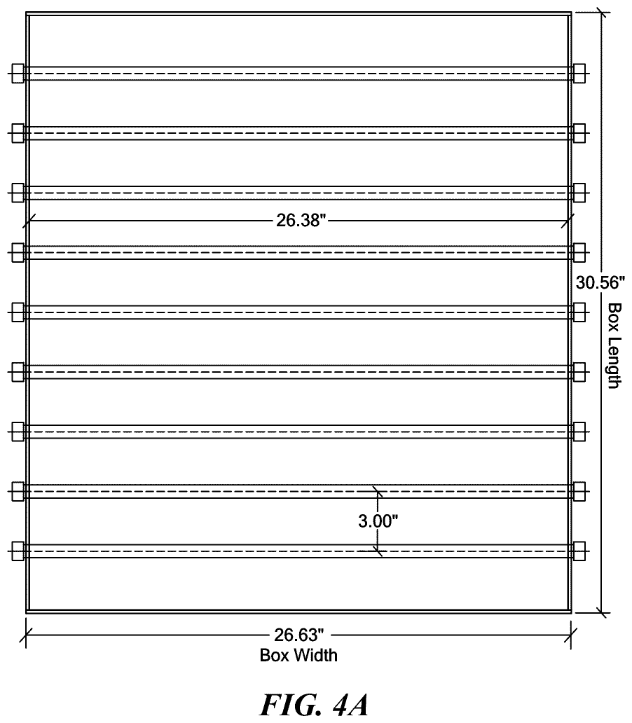

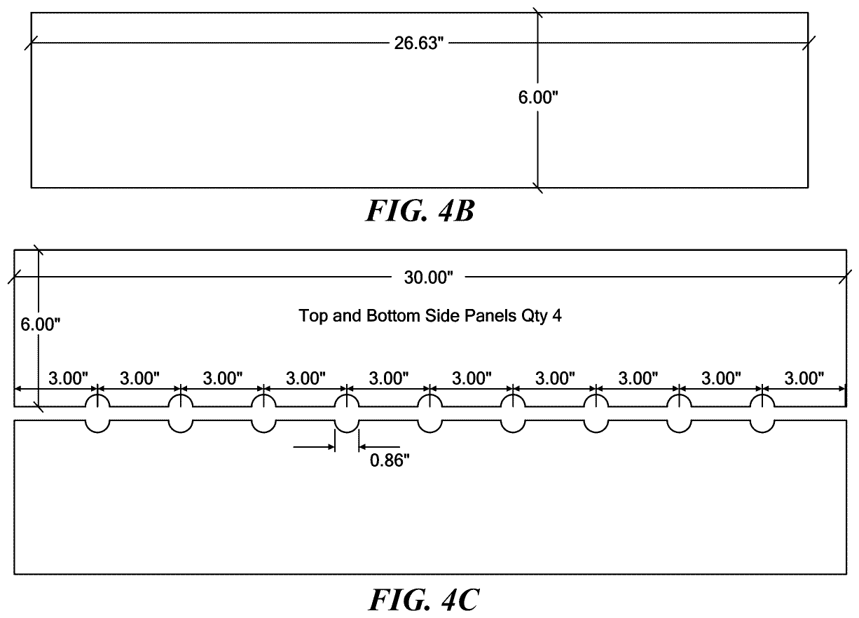

The following Examples are described in Tables 2, 3, 4, and 5. The Examples that were produced in a first prototype unit are listed under the Samples column as B9-EBO. The Examples that were produced in a second prototype unit, the furnace box shown in FIG. 2, are listed under the Samples column as B9-FB. The Examples that were produced in a third prototype unit, a continuous belt process oven, are listed under the Samples column as S1-S4. The Examples in Tables 2 and 3 are listed by increasing basicity of the finished dry product, going from low basicity, at about 23 percent basicity, to high basicity, at about 80 percent basicity. Table 2 includes the testing conditions with the weights, percentages, operating notes, temperatures, times, and number of layers of ACS applied per total run. Table 3 includes the analysis data, the formula calculations, and the sample formulas. Table 4 includes the testing conditions for the IR oven settings for Samples S1-S4. Table 5 includes the analysis data for Samples S1-S4.

TABLE 5
Powder Sample Analysis

| | | | | Calculated | | Dry BAC | Vapor |
|---|---|---|---|---|---|---|---|
| | Aluminum | Chloride | Basicity | Hydroxyl | Associated | Powder | Released |
| Sample | % | % | % | (OH) % | H₂0 % | Lbs/Hour | Lbs/Hour |
| S1 - P 044 | 21.07% | 33.11% | 60.13% | 23.95% | 21.87% | 13.62 | 37.09 |
| S2 - P 045 | 18.98% | 34.48% | 53.92% | 19.36% | 27.18% | 15.12 | 35.59 |
| S3 - P 046 | 16.28% | 37.33% | 41.77% | 12.85% | 33.58% | 21.18 | 39.67 |
| S4 - P 047 | 15.56% | 35.80% | 42.20% | 12.25% | 36.39% | 22.13 | 38.71 |

Wherein:
Al₍₂₎ OH_{(y)} Cl₍ₓ₎ * (n) H₂0

| Sample | OH (y) | Cl (x) | (n) H₂0 | Formula Weight |
|---|---|---|---|---|
| S1 - P 044 | 3.61 | 2.39 | 3.11 | 256.16 |
| S2 - P 045 | 3.24 | 2.78 | 4.29 | 284.24 |
| S3 - P 046 | 2.51 | 3.49 | 6.18 | 331.77 |
| S4 - P 047 | 2.50 | 3.50 | 7.00 | 346.68 |

TABLE 2

| | Testing Conditions | | | | | | | | |
|---|---|---|---|---|---|---|---|---|---|
| | Feed | Pump | Pump | Feed Max. | Low | Evap | | Bake | |
| | Mass | Speed | Stroke | feed Rate | Heat | Time | Bake | Time | |
| Sample | [kg] | [%] | [%] | [gph] | (° F.) | (min) | (° F.) | (min) | Observations/Comments |
| 89-EBO #12 | — | | | | — | — | 240 | 5 | Aluminum Chloride Hexahydrate baked |
| 89-EBO #11 | — | | | | — | — | — | — | Aluminum Chloride Hexahydrate |
| 89-FB #01 | 1.1 | 35% | 70% | 1.56 | 300 | 5 | — | — | First Furnace Box test - sample represents |
| | | | | | | | | | pre-decomposition bake. 5 layers applied |
| 89-FB #03 | 0.9 | 35% | 70% | 1.56 | 300 | 5 | — | — | Repeatability of FB#01 |
| 89-FB #09 | | 40% | 55% | 1.76 | 285 | 5 | — | — | 3X runs at 2 ft/min speed with new droplet manifested. |
| | | | | | | | | | Stroke the same as FB #08. Speed increased. All 3 runs @ |
| | | | | | | | | | 285 F. evap. |
| 89-EBO #16 | | | | | 240 | 5 | 375 | 5 | Aluminum Chloride Hexahydrate in 50/50 by |
| | | | | | | | | | weight. Not meant to undergo bake but sample was still |
| | | | | | | | | | liquidous and bake was needed. |
| 89-FB #21 | 0.50 | 30% | 60% | 1.44 | 285 | 5 | — | — | 4X runs at 2 ft/min. All 4 runs @ 285 F. evap. Emptied |
| | | | | | | | | | contents of belt into sample jar after each run and |
| | | | | | | | | | homogenized jar. Updated ACS header utilized - 25 |
| | | | | | | | | | orifices in total. |
| 89-FB #08 | 0.45 | 32% | 55% | 1.41 | 275/285 | 5 | — | — | 3X runs at 2 ft/min belt speed with new droplet manifold. |
| | | | | | | | | | Runs 1&2 with 275 F. evap and 3 was with 285 F. evap. |
| | | | | | | | | | Emptied contents of belt into sample jar after each run |
| | | | | | | | | | and homogenized jar. |
| 89-FB #10 | 0.35 | 40% | 55% | 1.76 | 285 | 7.5 | — | — | 3X runs at 2 ft/min. All 3 runs @ 285 F. evap. Emptied |
| | | | | | | | | | contents of belt into sample jar after each run and |
| | | | | | | | | | homogenized jar. Pump primed again prior to 3rd layer. |
| 89-FB #17 | 0.3 | 30% | 60% | 1.44 | 285 | 7.5 | — | — | 3X runs at 2 ft/min. All 3 runs @ 285 F. evap. Emptied |
| | | | | | | | | | contents of belt into sample jar after each run and |
| | | | | | | | | | homogenized jar. |
| 89-FB #22 | 0.45 | 30% | 60% | 1.44 | 285 | 5 | — | — | 4X runs at 2 ft/min. All 4 runs @ 285 F. evap. Pulled |
| | | | | | | | | | product out from under FB after 2 minutes and misted |
| | | | | | | | | | with 3 water sprays, then resumed evap. Each spray |
| | | | | | | | | | provided 3.8 g H2O. Emptied contents of belt into sample |
| | | | | | | | | | jar after each run and homogenized jar. |
| 89-FB #10 | — | | | | 240 | 5 | 375 | 5 | — |
| 89-FB #05 | — | — | — | — | — | — | — | — | FB#O4 test that was put through a grinder |
| 89-EBO #34 | — | | | | 240/270 | 5 | 375 | 10 | 3 low heats at 240 [symbol] . 2 low heats at 270, dispensed with |
| | | | | | | | | | roundup pump (larger scrubber used) |
| 89-EBO #38 | — | | | | — | — | — | — | — |
| 89-EBO #33 | — | | | | 240/270 | 5 | 375 | 10 | 3 low heats at 240 [symbol] . 2 low heats at 270, dispensed with |
| | | | | | | | | | roundup pump (larger scrubber used) |
| 89-FB 15 | 0.35 | 50% | 50% | 1.44 | 285 | 7.5 | — | — | 4X runs at 2 ft/min. All 4 runs @ 285 F. evap. Pulled |
| | | | | | | | | | product out from under FB after 3 minutes and misted |
| 89-EBO #28 | — | | | | 240 | 5 | 375 | 13 | 6 layers, spray before bake |
| 89-FB #28 | 0.25 | 30% | 50% | 1.44 | 315 | 5 | — | — | 3X runs at 2 ft/min. All at 315 F. evap. No bake. Pulled |
| | | | | | | | | | product out from under FB 2 minutes into each of the 3 bakes |
| | | | | | | | | | and sprayed 5X with water. Each spray provided 3.8 g |
| | | | | | | | | | H2O. Emptied contents of belt after third run into sample |
| | | | | | | | | | jar and homogenized. |
| 89-EBO #31 | — | | | | 240/270 | 5 | 375 | 10 | 3 low heats at 240. 2 low heats at 270, dispensed with |
| | | | | | | | | | hand spray |
| 89-EBO #31 | — | | | | 240/270 | 5 | 375 | 10 | 3 low heats at 240. 2 low heats at 270, dispensed with |
| | | | | | | | | | hand spray |
| 89-FB #23 | 0.20 | 30% | 60% | 1.44 | 300 | 5 | — | — | 3X layers at 2 ft/min. All at 300 F. evap. No bake. Emptied |
| | | | | | | | | | contents of belt after third run into sample jar and |
| | | | | | | | | | homogenized jar. |
| 89-EBO #27 | — | | | | 240 | 5 | 375 | 13 | 6 layers, spray before bake |
| 89-FB #07 | — | — | — | — | — | — | — | — | FB #06 test that was put through a grinder |
| 89-EBO #27 | — | | | | 240 | 5 | 375 | 13 | 6 layers, spray before bake |
| 89-FB #26 | 0.40 | 30% | 60% | 1.44 | 315 | 5 | — | — | 3X layers at 2 ft/min. All at 315 F. evap. No bake. Pulled |
| | | | | | | | | | product out from under FB and sprayed 5X with water |
| | | | | | | | | | after second crystallization, prior to 3rd ACS feed. Each |
| | | | | | | | | | spray provided 3.8 g H2O. Emptied contents of belt after |
| | | | | | | | | | third run into sample jar and homogenized. |
| 89-FB #11 | 0.45 | 30% | 45% | 1.08 | 285 | 7.5 | — | — | 4X runs at 2 ft/min. All 4 runs @ 285 F. evap. Emptied |
| | | | | | | | | | contents of belt into sample jar after each run and |
| | | | | | | | | | homogenized jar. |
| 89-FB #14 | 0.4 | 30% | 60% | 1.44 | 285 | 10 | — | — | 4X runs at 2 ft/min. All 4 runs @ 285 F. evap. Emptied |
| | | | | | | | | | contents of belt into sample jar after each run and |
| | | | | | | | | | homogenized jar. Updated ACS header utilized - 25 |
| | | | | | | | | | orifices in total. |
| 89-EBO #13 | — | | | | 240 | 5 | 375 | 10 | The silicone tube connection between oven and scrubber |
| | | | | | | | | | fell apart between end of EBO 13 and start of EBO 14. |
| 89-FB #29 | 0.30 | 30% | 60% | 1.44 | 315 | 5 | — | — | 3X layers at 2 ft/min. All at 315 F. evap. 3rd layer bake time |
| | | | | | | | | | at 7.5 min. No bake. Pulled product out from under FB 3 |
| | | | | | | | | | min into 3rd bake layer and sprayed 5X with water. |
| | | | | | | | | | Each spray provided 3.8 g H2O. Emptied contents of belt |
| | | | | | | | | | after third run into sample jar and homogenized. |
| 89-EBO #30 | — | | | | 240/270 | 5 | 375 | 10 | 4 low heats at 240, 5th at at 270, dispensed with roundup |
| | | | | | | | | | pump |
| 89-FB #16 | 0.20 | 30% | 60% | 1.44 | 285 | 7.5 | — | — | Repeat of 89-FB #13. 4X runs this time. |
| 89-FB #30 | 0.30 | 30% | 60% | 1.44 | 315 | 5 | — | — | 3X runs at 2 ft/min. All at 315 F. evap. 3rd layer bake time |
| | | | | | | | | | at 7.5 min. No bake. Pulled product out from under FB 3 |
| | | | | | | | | | min into the 3rd bake layer and sprayed 3X with water. |
| | | | | | | | | | Each spray provided 3.8 g H2O. Emptied contents of belt |
| | | | | | | | | | after third run into sample jar and homogenized. |
| 89-FB #27 | 0.25 | 30% | 60% | 1.44 | 315 | 5 | — | — | 3X runs at 2 ft/min. All at 315 F. evap. No bake. Pulled |
| | | | | | | | | | product out from under FB 2 minutes into the 3rd bake layer |
| | | | | | | | | | and sprayed 5X with water. Each spray provided 3.8 g |
| | | | | | | | | | H2O. Emptied contents of belt after third run into sample |
| | | | | | | | | | jar and homogenized. |
| 89-FB #26 | — | | | | 240 | 5 | 375 | 13 | repeat of EBO#23/24, worried dripping from cardboard |
| | | | | | | | | | affected results |
| 89-FB #17 | 0.35 | 30% | 60% | 1.44 | 285 | 7.5 | — | — | Repeat of 89-FB #15. |
| 89-FB #30A | 0.3 | 30% | 60% | 1.44 | 315 | 5 | — | — | Re-run of 89-FB #30 for repeatability |
| 89-FB #18 | 0.35 | 30% | 60% | 1.44 | 285 | 10.0 | — | — | 4X runs at 2 ft/min. All 4 runs @ 285 F. evap. Pulled |
| | | | | | | | | | product out from under FB after 4 minutes and misted |
| | | | | | | | | | with 3 water sprays, then resumed evap. Each spray |
| | | | | | | | | | provided 3.8 g H2O. Emptied contents of belt into sample |
| | | | | | | | | | jar after each run and homogenized jar. |
| 89-EBO #29 | — | | | | 240/270 | 5 | 375 | 10 | 4 low heats at 240, 5th at at 270, dispensed with hand |
| | | | | | | | | | sprayer |
| 89-EBO #26 | — | | | | 240 | 5 | 375 | 13 | repeat of EBO#23/24, worried dripping from cardboard |
| | | | | | | | | | affected results |
| 89-FB #29A | 0.25 | 30% | 60% | 1.44 | 315 | 5 | — | — | Re-run of 89-FB #29 |
| 89-FB #24 | 0.20 | 30% | 60% | 1.44 | 315 | 5 | — | — | 3X layers at 2 ft/min. All at 315 F. evap. No bake. Emptied |
| | | | | | | | | | contents of belt after third run into sample jar and |
| | | | | | | | | | homogenized jar. |
| 89-EBO #35 | — | | | | 240 | 5 | 375 | 13 | Repeat of EBO#19 |
| 89-EBO #20 | — | | | | 240 | 5 | 375 | 13 | 2 sprays with water from spray bottle before bake, the |
| | | | | | | | | | results had a greyer pigment to other samples. |
| 89-FB #02 | — | — | — | — | — | — | 375 | 10 | First Furnace Box test - sample represents |
| | | | | | | | | | post-decomposition bake. GREAT SUCCESS |
| 89-EBO #19 | — | | | | 240 | 5 | 375 | 13 | |
| 89-EBO #25 | — | | | | 240 | 5 | 375 | 13 | repeat of EBO#23/24, worried dripping from cardboard |
| | | | | | | | | | affected results |
| 89-EBO #18 | — | | | | 240 | 5 | 385 | 15 | Some of product stuck to can after baker during removal. |
| 89-FB #19 | 0.45 | 30% | 60% | 1.44 | 285 | 12.5 | — | — | 4X runs at 2 ft/min. All 4 runs @ 285 F. evap. Emptied |
| | | | | | | | | | contents of belt into sample jar after each run and |
| | | | | | | | | | homogenized jar. Updated ACS header utilized - 25 |
| | | | | | | | | | orifices in total. |
| 89-FB #12 | 0.3 | 30% | 45% | 1.08 | 285 | 10.0 | — | — | 4X runs at 2 ft/min. All 4 runs @ 285 F. evap. Emptied |
| | | | | | | | | | contents of belt into sample jar after each run and |
| | | | | | | | | | homogenized jar. |
| 89-FB #20 | 0.45 | 30% | 60% | 1.44 | 285 | 12.5 | — | — | 4X runs at 2 ft/min. All 4 runs @ 285 F. evap. Pulled |
| | | | | | | | | | product out from under FB after 2 minutes and misted |
| | | | | | | | | | with 3 water sprays, then resumed evap. Each spray |
| | | | | | | | | | provided 3.8 g H2O. Emptied contents of belt into sample |
| | | | | | | | | | jar after each run and homogenized jar. |
| 89-EBO #17 | — | | | | 240 | 5 | 375 | 15 | Spray nozzle losing consistency, may be a pressure issue, |
| | | | | | | | | | change in nozzles did not fix issue. |
| 89-EBO #5 | 1.0 | | | | 260 | 12 | 450 | 15 | back drip in scrubber |

[symbol]

indicates data missing or illegible when filed

TABLE 3

| | Analysis Data | | | Formula Calculations | | | | | | Sample Formula | | | |
|---|---|---|---|---|---|---|---|---|---|---|---|---|---|
| | | | % [symbol] | Calc | Al/Cl | OH/Al | Calc | Calc | H₂O | | | | [symbol] |
| Sample | % Al [symbol] O [symbol] | % Chloride | Basicity | Al % | Molar Ratio | mole ratio | OH % | H₂O % | mol | Al | OH | Cl | H₂O |
| 89-EBO #12 | 21.56% | 45.05% | −0.1 [symbol] % | 11.41% | 0.3328 | −0.0051 | −0.04 | 43.58% | 0.0242 | 2 | −0.01 | 6.01 | 11.44 |
| 89-EBO #11 | 21.73% | 44.70% | 1.41% | 11.50% | 0.3380 | 0.0416 | 0.30% | 43.50 | 0.0241 | 2 | 0.08 | 5.92 | 11.33 |
| 89-FB #01 | 22.96% | 36. [symbol] % | 23.50% | 12.15% | 0.4357 | 0.7060 | 5.40% | 45. [symbol] 1% | 0.0254 | 2 | 1.41 | 4.59 | 11.29 |
| 89-FB #03 | 23. [symbol] % | 34.30% | 31.34% | 12.67% | 0.4853 | 0.8403 | 7.51% | 45.51% | 0.0253 | 2 | 1.88 | 4.12 | 10.75 |
| 89-FB #09 | 26.20% | 37.30% | 31.78% | 13.86% | 0.4884 | 0.9520 | 8.32% | 40.52% | 0.0225 | 2 | 1.91 | 4.09 | 8.75 |
| 89-EBO #16 | 27.97% | 38.07% | 34.7 [symbol] % | 14.80% | 0.5109 | 1.0425 | 9.73% | 37.40% | 0.0208 | 2 | 2.09 | 3.91 | 7.57 |
| 89-FB #21 | 26.71% | 37.74% | 36.88% | 15.19% | 0.5289 | 1.1093 | 10.62% | 36.44% | 0.0282 | 2 | 2.22 | 3.78 | 7.18 |
| 89-FB #08 | 27.96% | 36.68% | 37.11% | 14.80% | 0.5300 | 1.1131 | 10.38% | 38.14% | 0.0212 | 2 | 2.23 | 3.77 | 7.72 |
| 89-FB #10 | 33.64% | 32.98% | [symbol] % | 17.80% | 0.7094 | 1.5903 | 17.83% | 31.37% | 0.0174 | 2 | 3.28 | 2.82 | 5.28 |
| 89-FB #13 | 34.19% | 33.3 [symbol] % | [symbol] % | 18.00% | 0.7131 | 1.5976 | 18.22% | 30.35% | 0.0168 | 2 | 3.20 | 2.80 | 5.02 |
| 89-FB #22 | 35.12% | 33.63% | [symbol] % | 18.59% | 0.7261 | 1.6229 | 19.01% | 28.77% | 0.0160 | 2 | 3.25 | 2.75 | 4.64 |
| 89-EBO #10 | 35.16% | 33.27% | [symbol] % | 18.61% | 0.7348 | 1.0392 | 19.23% | 28.90% | 0.0160 | 2 | 3.28 | 2.72 | 4.65 |
| 89-FB #05 | 35.49% | 33.57% | 54.55% | 18.78% | 0.7350 | 1.6394 | 19.41% | 28.24% | 0.0157 | 2 | 3.28 | 2.72 | 4.50 |
| 89-EBO #34 | 36.17% | 31.78% | 57.88% | 19.14% | 0.7911 | 1.7353 | 20.95% | 28.13% | 0.0156 | 2 | 3.47 | 2.53 | 4.40 |
| 89-EBO #38 | 35.49% | 30.33% | 59.03% | 18.78% | 0.8135 | 1.7707 | 20.96% | 29.92% | 0.0166 | 2 | 3.54 | 2.46 | 4.77 |
| 89-EBO #13 | 37.19% | 31.65% | 59.29% | 19.68% | 0.8170 | 1.7760 | 22.03% | 26.63% | 0.0148 | 2 | 3.55 | 2.45 | 4.05 |
| 89-FB #15 | 40.03% | 33.54% | 59.85% | 21.19% | 0.8301 | 1.7953 | 23.98% | 21.30% | 0.0118 | 2 | 3.59 | 2.43 | 3.01 |
| 89-EBO #28 | 42.27% | 34.77% | 60.58% | 22.37% | 0.8453 | 1.8170 | 25.62% | 17.24% | 0.0096 | 2 | 3.63 | 2.37 | 2.31 |
| 89-FB #28 | 41.18% | 33.24% | 61.32% | 21.79% | 0.8616 | 1.8394 | 25.27% | 19.70% | 0.0109 | 2 | 3.68 | 2.32 | 2.71 |
| 89-EBO #31 | 40.47% | 31.03% | 63.25% | 21.42% | 0.9068 | 1.8973 | 25.62% | 21.93% | 0.0122 | 2 | 3.79 | 2.21 | 3.07 |
| 89-EBO #32 | 42.08% | 30.61% | 65.12% | 22.27% | 0.9557 | 1.9536 | 27.42% | 19.70% | 0.0109 | 2 | 3.91 | 2.09 | 2.65 |
| 89-FB #23 | 43.09% | 30.19% | 66.02% | 22.80% | 0.9924 | 1.9924 | 28.64% | 18.37% | 0.0102 | 2 | 3.98 | 2.02 | 2.41 |
| 89-EBO #27 | 39.12% | 27.13% | [symbol] % | 20.73% | 1.0039 | 2.0039 | 26.18% | 25. [symbol] % | 0.0144 | 2 | 4.01 | 1.99 | 3.75 |
| 89-FB #07 | 42.97% | 29.71% | 66.86% | 22.74% | 1.0057 | 2.0056 | 28.75% | 18.80% | 0.0104 | 2 | 4.01 | 1.99 | 2.48 |
| 89-EBO #27 | 39.89% | 26.99% | 67.56% | 21.11% | 1.0277 | 2.0268 | 26.97% | 24.93% | 0.0138 | 2 | 4.05 | 1.95 | 3.54 |
| 89-FB #26 | 47.76% | 31.24% | 63.45% | 25.28% | 1.0632 | 2.0594 | 12.81% | 10.68% | 0.0059 | 2 | 4.12 | 1.88 | 3.26 |
| 89-FB #11 | 40.67% | 26.57% | 68.69% | 21.52% | 1.0644 | 2.0605 | 27.95% | 23.96% | 0.0133 | 2 | 4.12 | 1.88 | 3.33 |
| 89-FB #14 | 41.22% | 26.88% | 68.74% | 21.81% | 1.0662 | 1.0623 | 28.35% | 22.96% | 0.0127 | 2 | 4.12 | 1.88 | 3.15 |
| 89-EBO #13 | 42.11% | 22.37% | 68.84% | 22.28% | 1.0658 | 2.0883 | 29.01% | 21.33% | 0.0118 | 2 | 4.13 | 1.87 | 2.87 |
| 89-FB #29 | 43.43% | 27.26% | 69.92% | 22.98% | 1.1079 | 2.0974 | 30.38% | 19.38% | 0.0105 | 2 | 4.29 | 1.81 | 2.52 |
| 89-EBO #30 | 42.35% | 26.31% | 70.23% | 22.41% | 1.1195 | 2.1067 | 29.76% | 21.52% | 0.0119 | 2 | 4.21 | 1.79 | 2.87 |
| 89-FB #16 | 46.93% | 28.83% | 70.55% | 24.87% | 1.1318 | 2.1165 | 33.13% | 13.20% | 0.0073 | 2 | 4.23 | 1.77 | 3.59 |
| 89-FB #30 | 45.21% | 27.37% | 70.95% | 23.92% | 1.1485 | 2.1293 | 32.11% | 16.59% | 0.0092 | 2 | 4.26 | 1.74 | 2.06 |
| 89-FB #27 | 45.75% | 27.04% | 71.67% | 24.21% | 1.1763 | 2.1499 | 32.81% | 15.93% | 0.0088 | 2 | 4.30 | 1.70 | 1.97 |
| 89-EBO #26 | 43.27% | 25.02% | 72.29% | 22.90% | 1.2025 | 2.1684 | 31.30% | 20.78% | 0.0115 | 2 | 4.34 | 1.66 | 2.72 |
| 89-FB #17 | 48.62% | 26.51% | 73.86% | 25.73% | 1.2751 | 2.2158 | 35.93% | 11.83% | 0.0066 | 2 | 4.43 | 1.57 | 3.38 |
| 89-FB #30A | 50.20% | 27.13% | 74.36% | 26.83% | 1.2994 | 2.2304 | 37.72% | 8.32% | 0.0046 | 2 | 4.46 | 1.54 | 0.93 |
| 89-FB #18 | 50.36% | 26.92% | 74.37% | 26.65% | 1.3005 | 2.2311 | 37.48% | 8.95% | 0.0050 | 2 | 4.46 | 1.54 | 3.01 |
| 89-EBO #29 | 39.27% | 20.87% | 74.53% | 20.78% | 1.3083 | 2.2357 | 29.29% | 29.06% | 0.0161 | 2 | 4.47 | 1.53 | 4.19 |
| 89-EBO #26 | 47.66% | 24.52% | 75.34% | 25.22% | 1.3515 | 2.2601 | 39.93% | 14.33% | 0.0079 | 2 | 4.52 | 1.48 | 3.70 |
| 89-FB #29A | 49.59% | 24.55% | 76.15% | 26.25% | 1.3989 | 2.2852 | 37.81% | 11.30% | 0.0063 | 2 | 4.57 | 1.43 | 1.29 |
| 89-FB #24 | 53.00% | 25.76% | 76.70% | 28.05% | 1.4806 | 2.3010 | 40.68% | 5.51% | 0.0033 | 2 | 4.60 | 1.40 | 0.59 |
| 89-EBO #35 | 49.78% | 23.73% | 72.19% | 26.34% | 1.4594 | 2.3143 | 38.43% | 11.49% | 0.0064 | 2 | 4.63 | 1.37 | 3.31 |
| 89-EBO #20 | 49.52% | 23.50% | 73.26% | 26.21% | 1.4652 | 2.3175 | 38.28% | 12.01% | 0.0067 | 2 | 4.64 | 1.36 | 3.37 |
| 89-FB #02 | 45.50% | 21.47% | 77.38% | 24.08% | 1.4736 | 2.3214 | 35.25% | 19.22% | 0.0107 | 2 | 4.64 | 1.36 | 2.39 |
| 89-EBO #19 | 50.19% | 21.73% | 79.25% | 26.50% | 1.6060 | 2.3773 | 39.80% | 11.91% | 0.0066 | 2 | 4.75 | 1.25 | 1.34 |
| 89-EBO #25 | 47.07% | 19.35% | 80.29% | 24.91% | 1.6924 | 2.4088 | 37.82% | 17.92% | 0.0088 | 2 | 4.82 | 1.18 | 2.15 |
| 89-EBO #18 | 55.06% | 20.58% | 82.09% | 29.14% | 1.8606 | 2.4825 | 45.23% | 5.05% | 0.0028 | 2 | 4.92 | 1.08 | 0.52 |
| 89-FB #19 | 57.55% | 20.14% | 83.23% | 30.46% | 1.5871 | 2.4967 | 47.93% | 1.47% | 0.0008 | 2 | 4.99 | 1.01 | 0.14 |
| 89-FB #12 | 56.59% | 19.48% | 83.52% | 29.95% | 2.0238 | 2.5054 | 47.29% | 3.30% | 0.0018 | 2 | 5.01 | 0.99 | 0.33 |
| 89-FB #20 | 57.14% | 18.29% | 83.82% | 30.34% | 2.0587 | 2.5145 | 47.93% | 2.66% | 0.0014 | 2 | 5.03 | 0.97 | 0.25 |
| 89-EBO #17 | 57.27% | 18.24% | 84.73% | 30.31% | 2.1832 | 2.5420 | 48.56% | 2.89% | 0.0016 | 2 | 5.08 | 0.92 | 0.29 |
| 89-EBO #5 | 58.06% | 16.89% | 58.05% | 30.73% | 2.3901 | 2.5816 | 50.00% | 2.38% | 0.0013 | 2 | 5.16 | 0.84 | 0.23 |

[symbol]

indicates data missing or illegible when filed

TABLE 4
Aluminum chloride solution specifications:
AL % = 5.66%
CI % = 22.32%
Specific gravity = 1.28 gm/ml

| | IR Oven Settings | | | | | | | | | | | | | |
|---|---|---|---|---|---|---|---|---|---|---|---|---|---|---|
| | | | | | Heating | Heating | | | | Heating | Heating | | | |
| | | ACS Manifold Zone 1 | | | Zone 1A [symbol] | Zone 1B [symbol] | ACS Manifold Zone 2 | | | Zone 2A [symbol] | Zone 2B [symbol] | Total | Liquid | Belt 10 ft |
| | Belt speed | Stroke | Time | | % Power | % Power | Stroke | Time | | % Power | % Power | power | ACS | transit |
| Sample | feet/min | % | % | [symbol] /min | Setting | Setting | % | % | [symbol] /min | Setting | Setting | rate | lbs/hr | minutes |
| S1 - P 044 | 2.68 | 50 | 50 | 150 | 65 | 65 | 50 | 50 | 150 | 70 | 55 | 34.43 | 50.71 | 3.73 |
| S2 - P 045 | 3.2 | 50 | 50 | 150 | 65 | 65 | 50 | 50 | 150 | 70 | 60 | 35.10 | 50.71 | 3.13 |
| S3 - P 046 | 3.2 | 50 | 60 | 180 | 63 | 63 | 50 | 60 | 180 | 70 | 65 | 35.24 | 60.85 | 3.13 |
| S4 - P 047 | 3.2 | 50 | 60 | 180 | 63 | 63 | 50 | 60 | 180 | 70 | 65 | 35.24 | 60.85 | 3.13 |

[symbol]

indicates data missing or illegible when filed

### B9-EBO Examples

The samples labeled B9-EBO include data from a first scale prototype unit which consisted of an adapted tabletop infra-red oven. The samples from this first scale prototype unit validated the concepts of using direct radiant infrared radiation to basicity shift liquid aluminum chloride solution (ACS) by evaporative concentration by either concurrent, or separate stage “decomposition”, releasing HCl vapor by breaking waters of hydration; creating a molecule of HCl by releasing Cl— ion which captures a proton from a hydrogen bonded water of hydration, and the subsequent bonding of the remainder OH— hydroxyl to the aluminum atom, starting a polymerization sequence.

### B9-FB Examples

The samples labeled B9-FB include data from a second scale prototype unit which was a furnace box model, as shown in FIG. 2. The second scale prototype unit was a first level automation model featuring a single chamber temperature-controlled box/oven with multiple infrared heating elements fitted with a speed controlled sliding PTFE belt system. The heating elements were in perpendicular rows relative to the direction of belt travel, 3-inches apart from one another and at a height of 6-inches above the belt deck. The furnace box or oven was 2′×3.5′ rectangle made of 304 SS. Nine (9) total infrared quartz tube heaters, providing 1500 watts each, were installed inside the box, powered by 480v electrical connection. The tubes were approx. 6″ above the belt surface. The belt was made of Teflon coated fiberglass, 0.009 inches thick. As shown in FIG. 2, the other components of the second prototype unit included an LMI pump, with installed relief valve, (designated as i) which was used to feed ACS with max 8 gph capacity, a ⅛hP AC gear motor and VFD, along with gear rail, (designated as ii) which was used to move the belt forward and backward while dispersing the solution, and relays and sensors (designated as iii) which were used to cease the belt motion once dispersing was complete. The belt was manually pushed under the furnace at this point. An Emergency Stop (designated as iv) was installed to cut off power to heater controllers in the event of a process upset and venting (designated as v) was installed, with partial insulation, on top of the furnace box to a scrubber to capture fugitive emissions. Tubing, check valve and spray nozzles (designated as vi) were installed to transfer liquid ACS onto the belt, while preventing backflow/dripping, SCR controllers (designated as vii) were installed for temperature control of the quartz heaters within the furnace box, On/Off switches (designated as viii) were used for pump and belt operation, and two RTDs (designated as ix) were installed to measure both source and belt temperatures. The belt temperature was adjusted using 4-20 mA output to a controller. The furnace box tests typically included the following steps:

The LMI metering pump delivered aluminum chloride solution at a rate of 1.44 gph onto the belt, while the belt was moving at approx. 2 ft/min.

The dispersion area of material on the belt was approx. 24″×18″.

After 1 minute, the pump was stopped, and material began its first bake underneath the furnace box.

Bake time was 5 minutes at 315° F.

After 5 minutes, the material on the belt came out of the oven.

A second layer of ACS was fed onto the belt, on top of the first layer, at the same ACS feed rate while the belt was moving at the same speed, 1.44 gph and 2 ft/min, respectively.

After 1 minute, the pump was stopped and the second layer was baked under the furnace box for 5 minutes at 315° F.

After 5 minutes, the material on the belt came out of the oven.

A third and final layer of ACS was fed onto the belt, on top of the existing dried material, at 1.44 gph while the belt moved at 2 ft/min.

Third bake time was 7.5 minutes. Midway through the 3rd bake at approx. 3 minutes, material was taken out under the box and dispersed three times with water, providing approx. 3.8 g of water per dispersement on top of the ACS.

The material was fed back under the oven for the remainder of the 7.5 minutes.

After 7.5 minutes, material was taken out from under the box and removed from the belt for sample testing.

Important features of the furnace box system were the rate-controlled belt travel speed combined with an evolved liquid ACS delivery system (manifold) matched with a pump such that the distribution of the ACS was controlled as precise droplets of a diameter of about 3/16″ to about ⅜″, and about ¾″ apart from one another on-center. With these parameters and the natural surface tension of the droplets, the droplets did not substantially migrate, move, or coalesce into pools before drying.

The formation of individual droplets of approximate uniform size, mass, and, importantly, the high surface area to volume ratio, was important to satisfactory uniform final product.

The furnace box unit allowed exploring the favorable consequences of layering new droplets of ACS on top of previous layers of dried and/or dried and decomposed pre-exiting material, thereby modelling a system of progressive product loading on a single belt within a longer extended oven with multiple heating zones, and multiple ACS feed points, according to embodiments of the present invention.

Samples generated with basicities above 80 percent, which have, by calculation, less than about 1.0 to 1.2 waters of hydration dry mass dimer formula, were found to be mostly water insoluble or not useful and likely represent a process boundary that creates aluminum-oxy and aluminum hydroxy-oxy bonds which are not useful.

If samples of ASC-to-powder are nearly complete, or in process of late stage heating, re-wetted by misting with water while hot allowed the powder to more readily obtain the high basicity (e.g., >75% basic) dry product without issues of product water insolubility, which is also seen as dimer formula calculations of the associated waters of hydration [*₍ₙ₎H₂0] with n>1.0. The re-wetting of late-stage, in-process powder material was also seen to desirably increase the powder bulk density.

### S1-S4 Examples

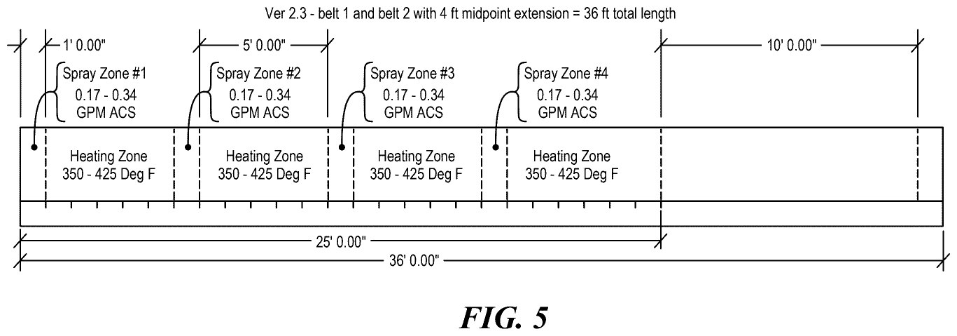

The samples labeled S1-S4 include data from a third prototype unit, which was a continuous belt process oven, as shown in FIG. 5. The oven consisted of 6, five-foot-long heating zones, separately insulated with an average oven width of 24 inches. Each heating zone had nine transverse-mounted 1.5 kW medium wavelength (2 to 4 microns) heating elements. The heating tubes were mounted level and 5-inches above the belt travel deck. At the leading edge of the belt oven, in front of the first zone, and between each heating zone was a six-inch insulated zone for a liquid manifold tube mounted perpendicular to the moving belt at an elevation of 4-inches for controlled distribution of Aluminum Chloride Solution (ACS). The manifold tubes were heat and corrosion resistant tantalum alloy and had downward facing 0.8 mm precision holes 0.5 inches apart for a centered span of 19-inches.

The oven interior was constructed of 316SS. The top and sides of each heating zone was closed to the belt deck. The front and rear of each heating zone was also partially enclosed with 1.5-inch full-width opening at the deck for the belt and product to enter and exit each zone. The top and sides of the oven system were insulated and shielded with 1 inch of rock wool covered with protective stainless steel sheeting. The entrance and exit gapped slots were enclosed above the 1.5-inch openings by a stainless steel baffle and ½-inch ceramic insulation.

The exhaust vapor was drawn from the center top of each heating zone by a 3-inch port, and from one top side of each manifold space with a 2-inch port. The exhaust system was maintained at minus 4 to 5 inches WC.

Each heating zone was controlled by individual SCR power modules and monitored by an RTD thermal sensor mounted under the belt in the center of each zone.

Each manifold used to feed ACS was fed by a precision electric pulse diaphragm pump with adjustable stroke volume and stroke interval setting such that droplets of ACS were delivered to the moving belt in uniform droplets of 3 to 10 mm diameter. For example, controlling the pump stroke volume determines the droplet sizes, and controlling the stroke frequency and the belt travel speed determines the droplet travel spacing.

The belt consisted of temperature resistant 23-inch-wide PTFE covered fiberglass. The belt speed was precisely controlled by VFD connected to the PLC which controlled each heating zone and the manifold pumps.

The manifolds were separately calibrated to determine the volume (milliliters) each manifold would deliver per pulse. The volume of ACS delivered per unit time was determined by the set stroke volume and the stroke pulses for each pump per minute.

The operational examples consisted of a demonstration of product layering and process control using one manifold feeding two heating zones followed by another manifold feeding onto the previously dried material, followed by two more heating zones. The system was operated continuously for several hours to test performance stability.

The continuous belt experimental configuration included two manifolds that were feeding ACS onto a moving PTFE belt. Each manifold was followed by two 5-foot-long heat zones (combined length 10 ft), each with nine 1.5 kW medium wavelength infrared tubes, for a total of 18 tubes per 10 ft. Each manifold distributed rows of droplets at 150 ml/min to 180 ml/min followed by the heating zones. The first manifold and first two heating zones led immediately into the second manifold and second two heating zones, effectively layering the liquid ACS droplets from the second manifold directly onto the dried crystalline powder emerging from the first two heating zones. This combined fresh liquid ACS, and the crystalline material then passed into the second two heating zones, which made a combined 10-foot-long heating zone. The power applied to each heating zone was regulated to a steady output to maintain a monitored deck temperature of between 370 deg F. and 420 deg F. The infrared lamps were not cycled on and off. They were modulated between 55% and 70% continuous output.

Total energy applied through all the heating zones was also modulated to achieve demonstratable dry crystalline powder at the end of the belt run as per each run series, increased ACS applied (mls/min) and/or increased belt speed generally required more power, or results in a lower basicity product.

In all cases, visible, rapid and expansive crystallization of the droplets was observed to be driven directly by the amount of apparent radiance of the IR lamps in the heating space concurrently with the net zone temperature, but the zone temperatures alone did not sufficiently and actively promote liquid drying and complete crystallization/transformation within the retention period of any zones. It was important that the infrared radiation be evenly steady state.

### Example S1-P 044—ACS Solution to 60.13% Basicity Powder

S1-P 044 Settings are provided below:

$$Total ACS input rate = 300 ml / min = 50.71 pounds / hour$$

$$Belt speed = 2.68 feet / minute therefore \\ a single 10 ft heat zone transite time = 3.73 minutes$$

$$Combined power rate for all infrared heaters = 34.43 kW$$

Results—dry powder analysis are provided below:

$$Aluminum \% = 21.07$$

$$Chloride \% = 33.11$$

$$Calculated Basicity \% = 60.13$$

$$Hydroxyl \% = 23.95$$

$$Associated Water content \% = 21.95$$

$$Aluminum dimer formula format \to {Al}_{2} {OH}_{( 3.61 )} {Cl}_{( 2.39 )} \times 3.11 {H}_{2} O$$

$$Formula weight : 256.16 gm / mole$$

$$Dry powder BAC production rate = 13.62 pounds / hour$$

$$Vapor released = 37.09 pounds / hour$$

Example S2-P 045—ACS solution to 53.92% basicity powder

S2-P 045 Settings are provided below:

$$Total ACS input rate = 300 ml / min = 50.71 pounds / hour$$

$$Belt speed = 3.2 feet / minute therefore \\ a single 10 ft heat zone transite time = 3.13 minutes$$

$$Combined power rate for all infrared heaters = 35.1 kW$$

Results-dry powder analysis are provided below:

$$Aluminum \% = 18.98$$

$$Chloride \% = 34.48$$

$$Calculated Basicity \% = 53.92$$

$$Hydroxyl \% = 19.36$$

$$Associated Water content \% = 27.18$$

$$Aluminum dimer formula format \to {Al}_{2} {OH}_{( 3.24 )} {Cl}_{( 2.76 )} \times 4.29 {H}_{2} O$$

$$Formula weight : 284.24 gm / mole$$

$$Dry powder BAC production rate = 15.12 pounds / hour$$

$$Vapor released = 35.59 pounds / hour$$

Example S3-P 046—ACS solution to 41.77% basicity powder

S3-P 046 Settings are provided below:

$$Total ACS input rate = 360 ml / min = 60.85 pounds / hour$$

$$Belt speed = 3.2 feet / minute therefore \\ a single 10 ft heat zone transite time = 3.13 minutes$$

$$Combined power rate for all infrared heaters = 35.24 kW$$

Results-dry powder analysis are provided below:

$$Aluminum \% = 16.26$$

$$Chloride \% = 37.33$$

$$Calculated Basicity \% = 41.77$$

$$Hydroxyl \% = 12.85$$

$$Associated Water content \% = 33.56$$

$$Aluminum dimer formula format \to {Al}_{2} {OH}_{( 2.51 )} {Cl}_{( 3.49 )} \times 6.18 {H}_{2} O$$

$$Formula weight : 331.77 gm / mole$$

$$Dry powder BAC production rate = 21.18 pounds / hour$$

$$Vapor released = 39.67 pounds / hour$$

Example S4-P 047—ACS solution to 42.20% basicity powder

S4 sample is a resample of the system running steady state 45 minutes after Example S3 with identical settings. This tested the system stability and product variance within a single process cycle.

S4-P 047 Settings are provided below:

$$Total ACS input rate = 360 ml / min = 60.85 pounds / hour$$

$$Belt speed = 3.2 feet / minute therefore \\ a single 10 ft heat zone transite time = 3.13 minutes$$

$$Combined power rate for all infrared heaters = 35.24 kW$$

Results—dry powder analysis are provided below:

$$Aluminum \% = 15.56$$

$$Chloride \% = 35.8$$

$$Calculated Basicity \% = 42.2$$

$$Hydroxyl \% = 12.25$$

$$Associated Water content \% = 36.39$$

$$Aluminum dimer formula format \to {Al}_{2} {OH}_{( 2.5 )} {Cl}_{( 3.5 )} \times 7. {H}_{2} O$$

$$Formula weight : 331.77 gm / mole$$

$$Dry powder BAC production rate = 21.13 pounds / hour$$

$$Vapor released = 38.71 pounds / hour$$

Although the above discussion discloses various exemplary embodiments, those skilled in the art may make various modifications to, or variations of, the illustrated embodiments without departing from the inventive concepts disclosed herein. For example, sulfated basic aluminum chloride dry products may be formed, rather than basic aluminum chloride dry products, with embodiments of the system and method described herein.

What is claimed is:

1. A method of producing particles of basic aluminum chloride, the method comprising:
dispensing droplets of a first liquid solution of aluminum chloride onto a surface;
heating the droplets of the first liquid solution with a first radiant heat source to concentrate the aluminum chloride to form at least partially dried particles of aluminum chloride;
dispensing droplets of a second liquid solution of aluminum chloride onto the surface between the at least partially dried particles of aluminum chloride from the first liquid solution;
heating the droplets of the second liquid solution with a second radiant heat source to concentrate the aluminum chloride to form at least partially dried particles of aluminum chloride; and
heating the at least partially dried particles of aluminum chloride from the first liquid solution and from the second liquid solution with a third radiate heat source to decompose the at least partially dried particles of aluminum chloride to produce the particles of the basic aluminum chloride.

2. The method according to claim 1, wherein the surface includes at least one conveyor belt configured to hold the droplets.

3. The method according to claim 1, wherein the surface is textured to hold the droplets.

4. The method according to claim 1, wherein the first radiant heat source and/or the second radiant heat source includes at least one electric powered heating element provided above and/or laterally adjacent to the surface and/or is provided perpendicular and/or parallel to a motion of the surface.

5. The method according to claim 4, wherein the first radiant heat source and/or the second radiant heat source is provided parallel to the motion of the surface, and further wherein the first radiant heat source and/or the second radiant heat source is inclined relative to the surface so that one end is further away from the surface than another end causing a radiant differential heating of the droplets.

6. The method according to claim 1, wherein the first radiant heat source and the second radiant heat source are the same heat source.

7. The method according to claim 1, wherein the first liquid solution and the second liquid solution are from one liquid source with the same concentration or the first liquid solution has a different concentration than the second liquid solution.

8. The method according to claim 1, wherein the droplets have an average size of about 0.5 mm to about 15 mm in diameter and are spaced apart from one another.

9. The method according to claim 1, further comprising:
adding water to the at least partially dried particles of aluminum chloride from the first liquid solution and/or from the second liquid solution to protect the at least partially dried particles from oxidation when decomposing to produce the particles of the basic aluminum chloride and/or
adding water to the particles of the basic aluminum chloride to change waters of hydration of the basic aluminum chloride and bulk density and solubility of the basic aluminum chloride.

10. The method according to claim 1, further comprising:
collecting gas emitted from the heated first liquid solution, the heated second liquid solution, and/or the heated at least partially dried particles of aluminum chloride, wherein the gas includes steam and/or hydrochloric acid released from the heated first liquid solution, the heated second liquid solution, and/or the heated at least partially dried particles of aluminum chloride.

11. The method according to claim 1, further comprising:
collecting heat emitted from the heated first liquid solution, the heated second liquid solution, and/or the heated at least partially dried particles of aluminum chloride.

12. A system for producing particles of basic aluminum chloride, the system comprising:
a liquid feed system configured to have a liquid solution of aluminum chloride and configured to dispense droplets of the liquid solution, the droplets having an average size of about 0.5 mm to about 15 mm in diameter and spaced apart from one another;
at least one conveyor belt having a surface configured to hold the droplets;
a first heating zone having at least one radiant heat source configured to heat the liquid solution on the surface to concentrate the aluminum chloride; and
a second heating zone having at least one radiant heat source configured to heat the concentrated aluminum chloride to decompose the aluminum chloride and produce the particles of basic aluminum chloride.

13. The system according to claim 12, wherein the liquid feed system includes a manifold with spaced apart apertures configured to dispense the droplets.

14. The system according to claim 12, wherein the liquid feed system is configured to control a size and density of the droplets by flowrate or pulse rate control.

15. The system according to claim 12, wherein the at least one radiant heat source in the first heating zone and/or the at least one radiant heat source in the second heating zone includes one or more electric powered heating elements provided above and/or adjacent to the surface.

16. The system according to claim 12, further comprising:
one or more gas collectors configured to collect gas emitted from the first heating zone and/or the second heating zone.

17. The system according to claim 12, further comprising:
one or more heat recouperators configured to collect heat emitted from the first heating zone and/or the second heating zone.

18. The system according to claim 12, further comprising:
one or more reflectors configured to return radiant energy to the surface reflected from the at least one radiant heat source in the first heating zone and/or from the at least one radiant heat source in the second heating zone.

19. The system according to claim 12, wherein the first heating zone has a temperature ranging from about 235 deg F. to about 400 deg F.

20. The system according to claim 12, wherein the second heating zone has a temperature ranging from about 250 deg F. to about 450 deg F.
